(19) United States
(12) Patent Application Publication
(10) Pub. No.: US 2012/0281589 A1
(43) Pub. Date: Nov. 8, 2012

(54) AUDIO QUALITY MEASUREMENT APPARATUS, AUDIO QUALITY MEASUREMENT METHOD, AND PROGRAM

(75) Inventor: Kazunori Ozawa, Tokyo (JP)

(73) Assignee: NEC CORPORATION, Tokyo (JP)

(21) Appl. No.: 13/575,211

(22) PCT Filed: Jan. 24, 2011
(86) PCT No.: PCT/JP2011/051162

§ 371 Date: Jul. 25, 2012

(30) Foreign Application Priority Data
Jan. 25, 2010 (JP) 2010-013098

(51) Int. Cl. H04L 12/26

(52) U.S. Cl. 370/252

(57) ABSTRACT

An audio quality measurement apparatus includes: a packet reception unit that picks up a packet conforming to a predetermined protocol from a network; an analysis unit that calculates a frame discard rate or a packet loss rate based on information stored in the packet; and a quality measurement unit that estimates audio quality based on the frame discard rate or the packet loss rate.

### TECHNICAL FIELD

### Description of Related Application

The present invention is based upon and claims the benefit of the priority of Japanese patent applications No. 2010-013098 filed on Jan. 25, 2010, the disclosure of which is incorporated herein in its entirety by reference thereto.

The present invention relates to an audio quality measurement apparatus, audio quality measurement method, and program that measure audio quality, and particularly to an audio quality measurement apparatus, audio quality measurement method, and program that measure the audio quality by picking up and analyzing a packet flowing in an IP (Internet Protocol) section of a network such as a mobile CSIP (Circuit Switched Internet Protocol) network or a mobile EPC (Evolved Packet Core) network.

### BACKGROUND

A device that picks up an audio packet flowing in a network such as a mobile network or IP network and analyzes the audio quality is known. For instance, an audio quality analysis apparatus that monitors the audio quality in a voice communication service by detecting a packet loss rate, round-trip delay or one-way delay, and jitter by means of analysis of a header such as a UDP (User Datagram Protocol) header or RTP (Real-time Transport Protocol) header, or of RTCP (Real-time Transport Control Protocol), detecting the degradation of audio quality when at least one of the above exceeds a predetermined threshold value, notifying the analysis results or the fact that the degradation has been detected to a host monitoring apparatus, and having the monitoring apparatus output/display these to/on a monitoring terminal as they are or after having processed or edited them has been put to practical use.

Patent Literature 1 describes a listening quality evaluation apparatus having a terminal side evaluate the listening quality of an audio-related IP packet media service provided via a packet communication network.

Further, Patent Literature 2 describes a network audio quality control target value calculating apparatus capable of managing a packet communication network while taking account of the influence of the burst loss of packets on the user's quality of experience of an application.

Further, Patent Literature 3 describes a network audio quality control target value calculating apparatus that calculates a network audio quality control target value comprising performance information actually measurable from a packet communication network in accordance with a subjective audio quality target value set to an audio-related application.

### Patent Literature 1

Japanese Patent Kokai Publication No. JP-P2008-172365A

### Patent Literature 2

Japanese Patent Kokai Publication No. JP-P2005-244609A

### Patent Literature 3

Japanese Patent Kokai Publication No. JP-P2004-023594A

### Non-Patent Literature 1

J. Sjoberg et al., “Real-Time Transport Protocol (RTP) Payload Format and File Storage Format for the Adaptive Multi-Rate (AMR) and Adaptive Multi-Rate Wideband (AMR-WB) Audio Codecs,” IETF (Internet Engineering Task Force) RFC (Request For Comment) 3267, [searched on Jan. 21, 2010], the Internet <http://www.ietf.org/rfc/rfc3267.txt>

### Non-Patent Literature 2

3GPP (3rd Generation Partnership Project) TS 25.415, “UTRAN Iu interface user plane protocols,” Ver. 8.0.0, [searched on Jan. 21, 2010], the Internet <http://www.3gpp.org/ftp/Specs/html-info/25415.htm>

### Non-Patent Literature 3

3GPP TS 26.102, “Mandatory speech codec; Adaptive Multi-Rate (AMR) speech codec; Interface to Iu, Uu and Nb,” Ver. 8.2.0, [searched on Jan. 21, 2010], the Internet <http://www.3gpp.org/ftp/Specs/html-info/26102.htm>

### Non-Patent Literature 4

Recommendation ITU-T P. 862, “Recommendation ITU-T P. 862: Perceptual evaluation of speech quality (PESQ): An objective method for end-to-end speech quality assessment of narrow-band telephone networks and speech codecs,” [searched on Jan. 21, 2010], the Internet <http://www.itu.int/rec/T-REC-P.862>

### Non-Patent Literature 5

3GPP TS 26.090, “Mandatory Speech Codec speech processing functions; Adaptive Multi-Rate (AMR) speech codec; Transcoding functions,” Ver. 8.1.0, [searched on Jan. 21, 2010], the Internet <http://www.3gpp.org/ftp/Specs/html-info/26090.htm>

### Non-Patent Literature 6

3GPP TS 23.401, “General Packet Radio Service (GPRS) enhancements for Evolved Universal Terrestrial Radio Access Network (E-UTRAN) access,” Ver. 9.3.0 [searched on Jan. 21, 2010], the Internet <http://www.3gpp.org/ftp/Specs/html-info/23401.htm>

### Non-Patent Literature 7

3GPP TS 29.163, “Interworking between the IP Multimedia (IM) Core Network (CN) subsystem and Circuit Switched (CS) networks,” Ver. 8.8.0 [searched on Jan. 21, 2010], the Internet <http://www.3gpp.org/ftp/Specs/html-info/29163.htm>

### SUMMARY

The entire disclosures of the above mentioned Patent Literatures and Non-Patent Literatures are incorporated herein by reference thereto. The following analysis is given by the present inventor.

Since the audio quality analysis apparatus described above can only perform analysis of, for instance, the RTP header of an RTP packet, there is a problem that the apparatus can only tell whether or not there is packet loss and measure a packet loss rate.

Further, there is a problem that the audio quality analysis apparatus above is not capable of picking up an IuUP (Iu User Plane) protocol frame or RFC (Request for Comments) 3267 payload format (Non-Patent Literature 1) flowing in a mobile core network to measure audio quality.

Further, there is a problem that the audio quality analysis apparatus above is not capable of estimating a subjective MOS (Mean Opinion Score) or PESQ (Perceptual Evaluation of Speech Quality) score from a packet loss rate.

Further, there is a problem that the audio quality analysis apparatus above is not capable of calculating the sound quality regarding a wireless access section and the sound quality regarding forwarding in a mobile core network while isolating one from the other.

These problems will be restrictions when audio quality is measured by picking up a packet flowing in a network in an actual operational environment.

Therefore, there is a need in the art to provide an audio quality measurement apparatus, audio quality measurement method, and program that measure audio quality based on a packet conforming to a predetermined protocol (for instance, the IuUP protocol or RFC3267 protocol) picked up from a mobile network.

An audio quality measurement apparatus relating to a first aspect of the present invention comprises:

a packet reception unit that picks up a packet conforming to a predetermined protocol from a network;
an analysis unit that calculates a frame discard rate or a packet loss rate based on information stored in the packet; and
a quality measurement unit that estimates audio quality based on the frame discard rate or the packet loss rate.

An audio quality measurement apparatus relating to a second aspect of the present invention comprises:

a packet reception unit that picks up a packet conforming to an IuUP (Iu User Plane) protocol from a network;
an IuUP analysis unit that calculates a frame discard rate based on at least one of a frame number, FQC (Frame Quality Classifier), header CRC (Cyclic Redundancy Check), and payload CRC stored in the packet; and
a quality measurement unit that estimates audio quality based on the frame discard rate.

An audio quality measurement apparatus relating to a third aspect of the present invention comprises:

a packet reception unit that picks up a packet conforming to an RFC (Request For Comments) 3267 protocol from a network;
an RFC3267 analysis unit that calculates a packet loss rate based on a Q bit stored in a payload of the packet; and
a quality measurement unit that estimates audio quality based on the packet loss rate.

An audio quality measurement method relating to a fourth aspect of the present invention comprises:

picking up a packet conforming to a predetermined protocol from a network;
calculating a frame discard rate or a packet loss rate based on information stored in the packet; and
estimating audio quality based on the frame discard rate or the packet loss rate.

An audio quality measurement method relating to a fifth aspect of the present invention comprises:

picking up a packet conforming to an IuUP (Iu User Plane) protocol from a network;
calculating a frame discard rate based on at least one of a frame number, FQC (Frame Quality Classifier), header CRC (Cyclic Redundancy Check), and payload CRC stored in the packet; and
estimating audio quality based on the frame discard rate.

A program relating to a sixth aspect of the present invention has a computer execute:

picking up a packet conforming to a predetermined protocol from a network;
calculating a frame discard rate or a packet loss rate based on information stored in the packet; and
estimating audio quality based on the frame discard rate or the packet loss rate.

The present invention provides the following advantage, but not restricted thereto. According to the audio quality measurement apparatus, the audio quality measurement method, and the program relating to the present invention, audio quality can be measured based on a packet conforming to a predetermined protocol (for instance, the IuUP protocol or the RFC3267 protocol) picked up from a mobile network.

### BRIEF DESCRIPTION OF THE DRAWINGS

FIG. 1 is a block diagram showing a configuration of an audio quality measurement apparatus relating to a first exemplary embodiment.

FIG. 2 is a block diagram showing a configuration in which the audio quality measurement apparatus relating to the first exemplary embodiment is applied to a mobile CSIP network.

FIG. 3 is a block diagram showing a configuration in which the audio quality analysis apparatus relating to the first exemplary embodiment is applied to a mobile LTE/EPC network.

FIG. 4 is a block diagram showing the configuration of an audio quality measurement apparatus relating to a second exemplary embodiment.

FIG. 5 is a block diagram showing a configuration in which the audio quality analysis apparatus relating to the second exemplary embodiment is applied to a connection between a mobile CSIP network and a fixed network.

FIG. 6 is a block diagram showing a configuration in which the audio quality analysis apparatus relating to the second exemplary embodiment is applied to a mobile LTE/EPC network.

### PREFERRED MODES

### First Exemplary Embodiment

In the present disclosure, there are various possible modes, which include the following, but not restricted thereto. An audio quality measurement apparatus relating to a first exemplary embodiment will be described with reference to the drawings.

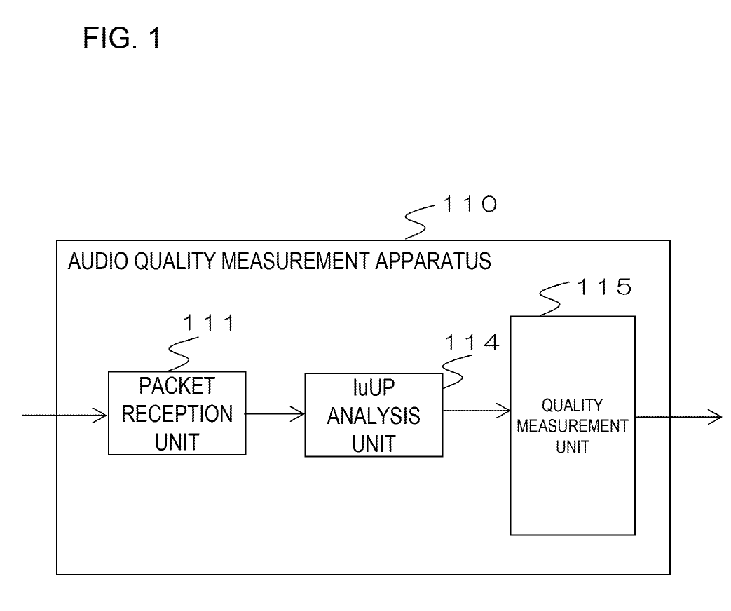

FIG. 1 is a block diagram showing a configuration of an audio quality measurement apparatus 110 relating to the present exemplary embodiment. In FIG. 1, the audio quality measurement apparatus 110 comprises a packet reception unit 111, an IuUP analysis unit 114, and a quality measurement unit 115.

The packet reception unit 111 receives an RTP packet, which stores an AMR (Adaptive Multi-Rate) IuUP protocol frame, picked up in an IP section of a mobile CSIP (Circuit Switched Internet Protocol) network, and output the packet to the IuUP analysis unit 114. Here, details of the IuUP protocol frame are defined in, for instance, 3GPP (3rd Generation Partnership Project) TS 25.415 standard (Non-Patent Literature 2) and TS 26.102 standard (Non-Patent Literature 3).

The IuUP analysis unit 114 performs analysis on occurrence of bit errors and audio quality degradation due to discarded IuUP frames. More concretely, the IuUP analysis unit 114 analyzes the IuUP protocol frame stored in the payload of the RTP packet and performs the following processing.

1. The IuUP analysis unit 114 refers to the value of the FQC (Frame Quality Classifier) field stored in the header of the IuUP protocol frame, counts the number of frames having a FQC field value other than 0 (Good) (for instance, 1, 2, etc.) during an observation period (referred to as “T”), calculates a frame discard rate_{—}1 based on the following expression, and outputs the calculated frame discard rate_{—}1 to the quality measurement unit 115.

Frame discard rate_{—}1=(N/M)*100 (1)

Here, N in Expression (1) denotes the number of frames having a FQC field value other than 0 during the observation period T. Meanwhile, M in the Expression (1) denotes the total number of RTP packets during the observation period T (i.e., the total number of IuUP frames during the observation period T).

2. The IuUP analysis unit 114 recalculates the header CRC (Cyclic Redundancy Check) value according to a method described in 3GPP TS 25.415 standard (Non-Patent Literature 2), and determines whether or not it matches a header CRC value stored in the IuUP protocol frame. When these values do not match, the frame is discarded due to CRC NG and the IuUP analysis unit 114 calculates a frame discard rate_{—}2 and outputs it to the quality measurement unit 115.

3. The IuUP analysis unit 114 recalculates the payload CRC value according to a method described in 3GPP TS 25.415 standard (Non-Patent Literature 2), and determines whether or not it matches a payload CRC value stored in the IuUP protocol frame. When these values do not match, the frame is discarded due to CRC NG and the IuUP analysis unit 114 calculates a frame discard rate_{—}3 and outputs it to the quality measurement unit 115.

The quality measurement unit 115 receives the frame discard rate_{—}1, the frame discard rate_{—}2, and the frame discard rate_{—}3 outputted from the IuUP analysis unit 114 during the predetermined observation period T, and calculates the total frame discard rate according to the following expression.

Total frame discard rate=frame discard rate_{—}1+frame discard rate_{—}2+frame discard rate_{—}3 (2)

Next, a relationship between the total frame discard rate and a subjective evaluation value MOS is prepared offline in advance based on experiments using a large amount of data, and the quality measurement unit 115 estimates a MOS value (MOS_e) from the total frame discard rate using this relationship and outputs the MOS_e value.

When a frame is discarded, a mobile terminal on the other side or a gateway connected to the other side interpolates the audio by frame error concealment processing, degrading the audio quality. The quality measurement unit 115 estimates the MOS value by utilizing the fact that the higher the frame discard rate is, the more the number of times frame error concealment processing is performed increases, thereby reducing the MOS value.

Further, as an alternative method, a PESQ value, an objective evaluation value, may be used instead of the subjective evaluation value MOS. In other words, a relationship between the total frame discard rate and the PESQ value may be prepared offline in advance based on experiments, and the quality measurement unit 115 may estimate a PESQ value from the total frame discard rate and output the estimated PESQ value. Details of PESQ are described in Recommendation ITU-T P. 862 (Non-Patent Literature 4).

It is possible to perform various modifications on the configuration of the audio quality measurement apparatus 110 shown in FIG. 1.

In the configuration of FIG. 1, the audio quality is calculated from the total frame discard rate obtained by summing all the three types of frame discard rates. However, the audio quality may be calculated for each of the three frame discard rates and the calculated audio quality may be outputted separately. In this case, audio quality attributed to an error in a wireless access section and audio quality regarding a core network section can be separated.

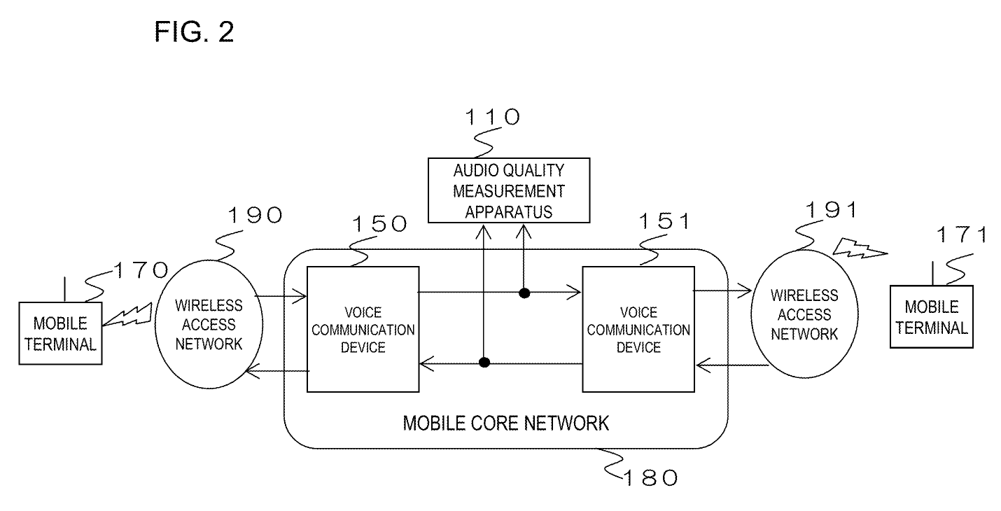

FIG. 2 illustrates a configuration as an example in which the audio quality measurement apparatus 110 relating to the present exemplary embodiment is connected in an IP section of a mobile CSIP network to perform quality measurement in communication between mobile terminals using the mobile CSIP network.

In FIG. 2, mobile terminals 170 and 171 perform voice communication (voice telephony) via a wireless access network 190, a mobile core network 180, and a wireless access network 191. The mobile core network 180 is a CSIP (Circuit Switched over IP) network as an example. In other words, a circuit-switched voice signal is converted into an RTP packet by voice communication devices 150 and 151, and sent to the mobile core network 180.

The terminal 170 converts a received voice signal into a compressed encoded bit stream using an audio compression encoding method built into the terminal and output the bit stream. For instance, as the audio compression encoding method, the AMR (Adaptive Multi-Rate) speech codec is used at a bit rate of 12.2 kbps. Details of the AMR are defined in, for instance, 3GPP TS 26.090 (Non-Patent Literature 5) standard.

The AMR bit stream goes through the wireless access network 190 and is stored in an IuUP (Iu User Plane) protocol frame when being sent to the mobile core network 180 from the wireless access network 190. The IuUP protocol frame reaches the mobile core network 180 and is supplied to the voice communication device 150.

Here, it is assumed that the mobile terminals 170 and 171 perform voice communication in TrFO (Transcoder Free Operation) bypassing audio codecs, as an example. Therefore, after storing the IuUP protocol frame in the payload of an RTP packet, the voice communication device 150 sends the RTP packet to the voice communication device 151 on the other terminal's side using RTP/UDP/IP protocol.

The voice communication device 151 receives the RTP packet, takes out the IuUP protocol frame stored in the RTP payload, and outputs it to the wireless access network 191. In the wireless access network 191, the 12.2 kbps AMR bit stream stored in the IuUP protocol frame is taken out and sent to the mobile terminal 171.

The mobile terminal 171 receives the 12.2 kbps AMR bit stream, decodes the bit stream, and plays back the audio.

Note that explanation of the voice communication in the direction from the mobile terminal 171 to the mobile terminal 170 will be omitted since the direction of the voice communication above is simply reversed.

The audio quality measurement apparatus 110 picks up an IuUP protocol frame in an RTP packet storing K channel's worth (K≧1) of IuUP protocol frames in both directions including an uplink direction (for instance, the direction from the voice communication device 150 to the voice communication device 151) and a downlink direction (for instance, the direction from the voice communication device 151 to the voice communication device 150) of an IP section of the mobile core network 180, analyzes the IuUP protocol frame for the uplink and downlink directions based on the configuration shown in FIG. 1, and measures the audio quality.

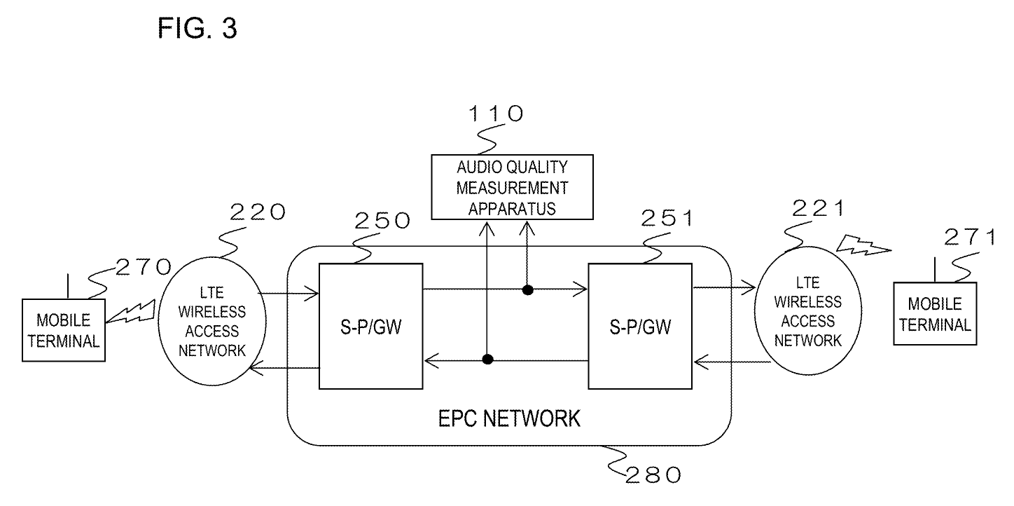

FIG. 3 illustrates a configuration as an example in which the audio quality measurement apparatus 110 of the present exemplary embodiment is applied to an LTE/EPC network. Here, LTE stands for Long Term Evolution, and EPC Evolved Packet Core. Details of EPC are defined in 3GPP TS 23.401 standard (Non-Patent Literature 6). In FIGS. 1 to 3, constituent elements given the same symbols perform the same operations.

From a mobile terminal 270 to the LTE, an AMR stream is stored in the RFC3267 payload format, this is further stored in the payload of an RTP packet, a UDP/IP transport is transmitted over an LTE bearer, and an LTE wireless access network 220 receives it.

In the LTE wireless access network 220, the RFC3267 payload format is converted into an IuUP protocol frame, which is stored in the payload of an RTP packet and sent to an S-P/GW 250 in the mobile EPC network. Here, S-P/GW is a general term for S-GW and P-GW; S-GW means Serving GW (Gateway) and P-GW Packet Data Network GW.

The IuUP protocol frame is forwarded between the S-P/GW 250 and an S-P/GW 251 while being stored in the payload of the RTP/UDP/IP packet.

The S-P/GW 251 on the other side receives the IuUP protocol frame and forwards it to an LTE wireless access network 221.

The LTE wireless access network 221 converts the IuUP protocol frame stored in the RTP payload into the RFC3267 payload format, stores the RFC3267 payload format packet in the payload of an RTP packet, and transmits the RTP/UDP/IP to a mobile telephone 271 on the other side over an LTE bearer.

The mobile telephone 271 receives the RTP packet, extracts the AMR stream stored in the RFC3267 payload format in the RTP payload, decodes it using an AMR decoder, and plays back the audio.

Note that explanation of the voice communication in the direction from the mobile terminal 271 to the mobile terminal 270 will be omitted since the direction of the voice communication above is simply reversed.

The audio quality measurement apparatus 110 picks up K channel's worth (K≧1) of IuUP protocol frames stored in uplink and downlink RTP packets and exchanged in an IP section between the S-P/GW 250 and the S-P/GW 251, and measures the audio quality based on the configuration shown in FIG. 1.

### Second Exemplary Embodiment

An audio quality measurement apparatus relating to a second exemplary embodiment will be described with reference to the drawings.

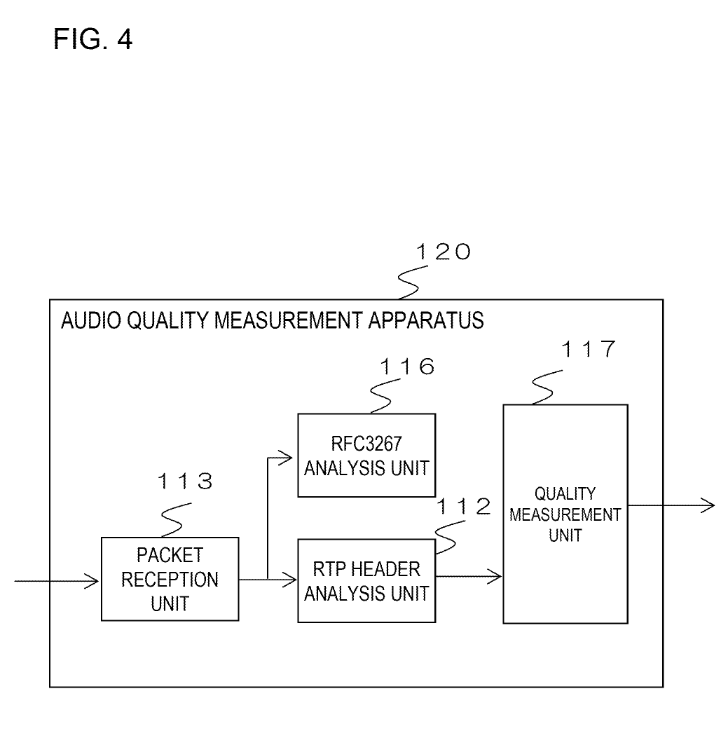

FIG. 4 is a block diagram showing a configuration of an audio quality analysis apparatus 120 according to the present exemplary embodiment. In FIG. 4, the audio quality analysis apparatus 120 comprises a packet reception unit 113, an RFC3267 analysis unit 116, an RTP header analysis unit 112, and a quality measurement unit 117.

The packet reception unit 113 receives an RTP packet storing an AMR RFC3267 payload picked up in an IP section of a mobile CSIP network, and outputs the packet to the RTP header analysis unit 112 and the RFC3267 analysis unit 116.

The RTP header analysis unit 112 performs the following (packet loss) analysis. The RTP header analysis unit 112 investigates the continuity of sequence numbers stored in the RTP header for a predetermined observation period T (for instance, several seconds), determines that there is packet loss when the sequence numbers are not sequential (i.e., there is a lack of continuity), calculates a packet loss rate L_{—}1 during the observation period T, and outputs it to the quality measurement unit 117.

The RFC3267 analysis unit 116 refers to a Q bit value in the RFC3267 payload format header stored in the RTP payload. When this value is 0 (Damaged), the RFC3267 analysis unit determines that the AMR bit stream stored in the RFC3267 payload is likely to include an error, counts the number of packets having a Q bit value of 0 during the observation period T, calculates a packet error rate L_{—}2 according to the following expression, and outputs the result to the quality measurement unit 117.

L_{—}2=P/M (3)

Here, P in Expression (3) denotes the number of packets having a Q bit value of 0 during the observation period T. Meanwhile, M in Expression (3) denotes the total number of RTP packets during the observation period T, as in M in Expression (1).

The quality measurement unit 117 receives L_{—}1 from the RTP header analysis unit 113 and L_{—}2 from the RFC3267 analysis unit 116, and calculates a total packet loss rate L_T for each observation period T according to the following expression.

L_{—}T=L_{—}1+L_{—}2 (4)

Further, as the quality measurement unit 115 (FIG. 1) in the first exemplary embodiment, a relationship between the total packet loss rate and a subjective evaluation value MOS is prepared offline in advance based on experiments using a large amount of data, and the quality measurement unit 117 estimates a MOS value (MOS_e) from the total packet loss rate using this relationship and outputs the MOS_e value.

In other words, as the first exemplary embodiment utilizes the fact that the MOS value decreases as the frame discard rate increases, the quality measurement unit 117 of the present exemplary embodiment estimates the MOS value by utilizing the fact that the MOS value decreases as the packet loss rate increases.

Further, as an alternative method, a PESQ value, an objective evaluation value, may be used instead of the subjective evaluation value MOS. In other words, a relationship between the total packet loss rate and the PESQ value may be prepared offline in advance based on experiments, and the quality measurement unit 117 may estimate a PESQ value from the total packet loss rate and output the estimated PESQ value.

It is possible to perform various modifications on the configuration of the audio quality measurement apparatus 120 shown in FIG. 4.

In the configuration of FIG. 4, the audio quality is calculated from the total packet discard rate L_T obtained by summing all the packet discard rates. However, the audio quality may be calculated from each of the packet discard rates L_{—}1 and L_{—}2 and the calculated audio quality may be outputted separately. At this time, audio quality regarding a core network section and audio quality attributed to an error in a wireless access section can be separated.

Further, in the configuration shown in FIG. 4, the audio quality is measured based on both the packet discard rate according to the Q bit of RFC3267 and the packet discard rate according to the discontinuity of the sequence numbers in the RTP header. The audio quality, however, may be measured based on the packet discard rate according to only the Q bit of RFC3267. In this case, although the processing amount can be reduced, an error in a wireless access section is not reflected in the audio quality.

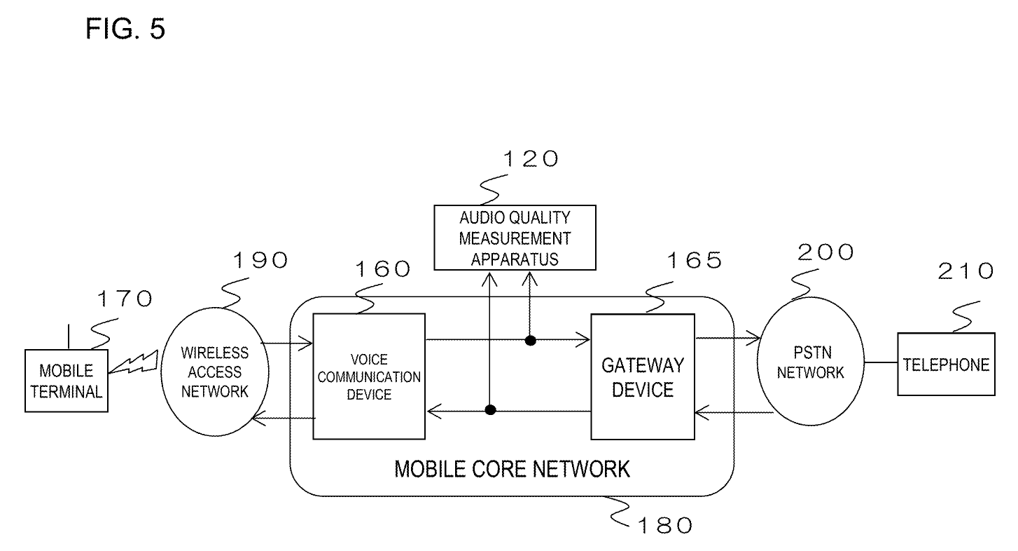

FIG. 5 illustrates a configuration as an example in which a CSIP network and a fixed network are connected, and quality measurement is performed by connecting the audio quality measurement apparatus 120 relating to the present exemplary embodiment in an IP section of the mobile CSIP network when voice communication is performed between a mobile terminal connected to the CSIP network and a fixed terminal connected to the fixed network. In FIGS. 2 and 5, constituent elements given the same symbols perform the same operations.

In FIG. 5, the mobile terminal 170 converts a received voice signal into a compressed encoded bit stream using an audio compression encoding method built into the terminal and output the bit stream. For instance, as the audio compression encoding method, the AMR (Adaptive Multi-Rate) speech codec is used at a bit rate of 12.2 kbps.

The AMR bit stream goes through the wireless access network 190 and is stored in an IuUP protocol frame when being sent to the mobile core network 180 from the wireless access network 190. The IuUP protocol frame reaches the mobile core network 180 and is supplied to the voice communication device 160.

The voice communication device 160 extracts header information regarding the 12.2 kbps AMR bit stream and the bit stream from the IuUP protocol frame, and stores them in the payload of an RTP packet. Here, in a case where the terminal on the other side is a terminal in a fixed network and not a mobile terminal, using the RTP payload format defined in IETF RFC3267 when the header information and the bit stream are stored in the RTP payload is standardized by, for instance, 3GPP TS 29.163 standard (Non-Patent Literature 7). Therefore, the voice communication device 160 constructs the payload format according to RFC3267, transfers from the IuUP frame format to the payload format including the Q bit of RFC3267, stores the 12.2 kbps AMR bit stream in the payload according to RFC3267, and sends the RTP packet to a gateway device 165 using RTP/UDP/IP protocol.

The gateway device 165 receives the RTP packet, checks the RFC3267 payload format, performs codec conversion on the 12.2 kbps AMR stream stored in the payload according to RFC3267 into a G.711 stream, and outputs the converted G.711 stream to a PSTN (Public Switched Telephone Network) 200 using the STM (Synchronous Transfer Mode).

A telephone 210 is connected to the PSTN 200 and receives a voice signal.

Note that explanation of the voice communication in the direction from the telephone 210 to the mobile terminal 170 will be omitted since the direction of the voice communication above is simply reversed.

The audio quality measurement apparatus 120 picks up packets of K channel's worth (K≧1) using the RFC3267 payload format stored in uplink and downlink RTP packets and exchanged in an IP section between the voice communication device 160 and the gateway 165, and measures the audio quality of the packets using the RFC3267 payload format based on the configuration shown in FIG. 4.

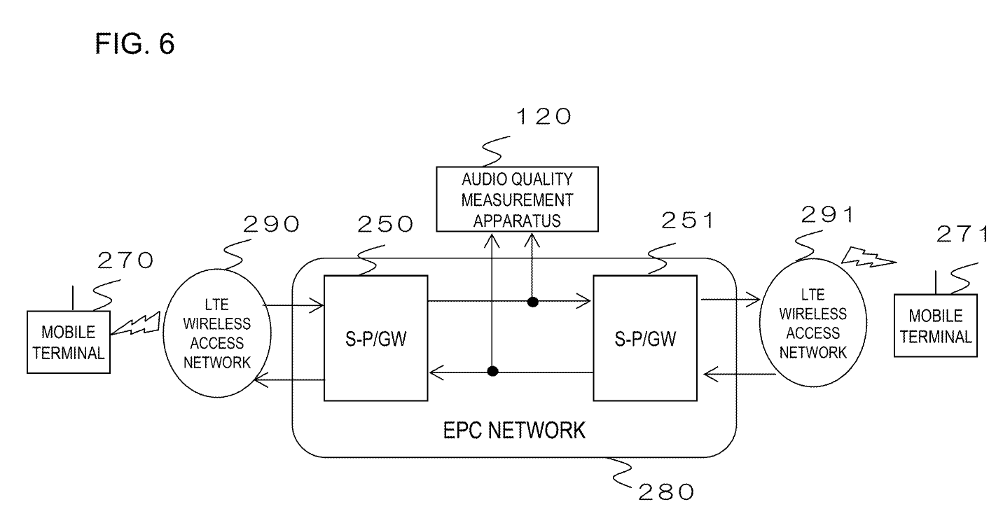

FIG. 6 illustrates a configuration as an example in which the audio quality measurement apparatus 120 of the present exemplary embodiment is applied to an LTE/EPC network. In FIGS. 4 to 6, constituent elements given the same symbols perform the same operations.

From the mobile terminal 270 to the LTE, an AMR stream is stored in the RFC3267 payload format, this is further stored in the payload of an RTP packet, a UDP/IP transport is transmitted over an LTE bearer, and the S-P/GW 250 in the mobile EPC network receives it via an LTE wireless access network 290. Here, S-P/GW is a general term for S-GW and P-GW; S-GW means Serving GW and P-GW Packet Data Network GW.

The packet using the RFC3267 payload format is forwarded between the S-P/GW 250 and the S-P/GW 251 while being stored in the RTP/UDP/IP packet. The S-P/GW 251 receives it and forwards it to an LTE wireless access network 291.

The LTE wireless access network 291 keeps the RTP/UDP/IP in the RFC3267 format and transmits it to the mobile telephone 271 on the other side over an LTE bearer.

The mobile telephone 271 receives it, extracts the AMR stream stored in the RFC3267 payload format, decodes it using an AMR decoder, and plays back the audio.

Note that explanation of the voice communication in the direction from the mobile terminal 271 to the mobile terminal 270 will be omitted since the direction of the voice communication above is simply reversed.

The audio quality monitoring apparatus 120 picks up K channel's worth (K≧1) of packets using the RFC3267 payload format stored in uplink and downlink RTP packets and exchanged in an IP section between the S-P/GW 250 and the S-P/GW 251, and measures the audio quality of the information stored in the RFC3267 payload format based on the configuration shown in FIG. 4.

The audio quality measurement apparatuses of the exemplary embodiments above are able to estimate and output a subjective MOS value or PESQ value by analyzing IuUP protocol frames flowing in a mobile CSIP or mobile LTE/EPC core network and calculating a frame discard rate based on at least one of the following pieces of information: frame number, FQC, header CRC, and payload CRC stored therein. Such an audio quality measurement apparatus requires a very small processing amount and no reference signal, and it is highly convenient.

Further, the audio quality measurement apparatuses of the exemplary embodiments above are able to estimate and output a subjective MOS value or PESQ value by analyzing packets using the RFC3267 payload format protocol flowing in a mobile CSIP or mobile LTE/EPC core network and calculating a frame discard rate based only on the Q bit or on both the Q bit and sequence numbers. Such an audio quality measurement apparatus requires a very small processing amount and no reference signal, and it is highly convenient.

Further, in the exemplary embodiments above, audio quality regarding a wireless access network and audio quality regarding forwarding in a core network can be separated by outputting audio quality based on a packet discard rate and audio quality based on each frame discard rate separately.

Modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept.

Further, the present invention includes inventions added below.

### Appendix 1

An audio quality measurement apparatus comprising:
a packet reception unit that picks up a packet conforming to an IuUP (Iu User Plane) protocol from a network;
an IuUP analysis unit that calculates a frame discard rate based on at least one of a frame number, FQC (Frame Quality Classifier), header CRC (Cyclic Redundancy Check), and payload CRC stored in the packet; and
a quality measurement unit that estimates audio quality based on the frame discard rate.

### Appendix 2

The audio quality measurement apparatus according to Appendix 1, wherein
the IuUP analysis unit calculates a frame discard rate based on a ratio in which the FQC is at a predetermined value, the FQC being stored in each of a plurality of packets picked up during a predetermined time period.

### Appendix 3

The audio quality measurement apparatus according to Appendix 1 or 2, wherein
the IuUP analysis unit recalculates a header CRC value of each of a plurality of packets picked up during a predetermined time period, and calculates a frame discard rate based on a ratio of the recalculated header CRC values of the packets matching header CRC values stored in the packets.

### Appendix 4

The audio quality measurement apparatus according to any one of Appendixes 1 to 3, wherein
the IuUP analysis unit recalculates a payload CRC value of each of a plurality of packets picked up during a predetermined time period, and calculates a frame discard rate based on a ratio of the recalculated payload CRC values of the packets matching payload CRC values stored in the packets.

### Appendix 5

The audio quality measurement apparatus according to any one of Appendixes 2 to 4, wherein
the quality measurement unit estimates audio quality based on a frame discard rate obtained by summing a plurality of frame discard rates calculated by the IuUP analysis unit using methods different from each other.

### Appendix 6

An audio quality measurement apparatus comprising:
a packet reception unit that picks up a packet conforming to an RFC (Request For Comments) 3267 protocol from a network;
an RFC3267 analysis unit that calculates a packet loss rate based on a Q bit stored in a payload of the packet; and
a quality measurement unit that estimates audio quality based on the packet loss rate.

### Appendix 7

The audio quality measurement apparatus according to Appendix 6, wherein
the RFC3267 analysis unit calculates a packet loss rate based on a ratio in which the Q bit is at a predetermined value, the Q bit being stored in each of a plurality of packets picked up during a predetermined time period.

### Appendix 8

The audio quality measurement apparatus according to any one of Appendixes 1 to 7, wherein
the quality measurement unit estimates audio quality in terms of a MOS (Mean Opinion Score) value or a PESQ (Perceptual Evaluation of Speech Quality) value.

### Appendix 9

The audio quality measurement apparatus according to Appendix 8, wherein the quality measurement unit estimates a MOS value or a PESQ value from a frame discard rate or a packet loss rate using a relationship between the frame discard rate or the packet loss rate and MOS or PESQ values prepared offline in advance based on experiments using a large amount of data.

### Appendix 10

The audio quality measurement apparatus according to any one of Appendixes 1 to 9, wherein
the network is a mobile CSIP (Circuit Switched Internet Protocol) network or a mobile EPC (Evolved Packet Core) network.

### Appendix 11

An audio quality measurement method comprising:
by a computer, picking up a packet conforming to an IuUP (Iu User Plane) protocol from a network;
calculating a frame discard rate based on at least one of a frame number, FQC (Frame Quality Classifier), header CRC (Cyclic Redundancy Check), and payload CRC stored in the packet;
estimating audio quality based on the frame discard rate.

### Appendix 12

The audio quality measurement method according to Appendix 11, comprising:
by the computer, calculating a frame discard rate based on a ratio of FQCs stored in each of a plurality of packets picked up during a predetermined time period being a predetermined value.

### Appendix 13

The audio quality measurement method according to Appendix 11 or 12, comprising:
by the computer, recalculating a header CRC value of each of a plurality of packets picked up during a predetermined time period, and calculate a frame discard rate based on a ratio of the recalculated header CRC values of the packets matching header CRC values stored in the packets.

### Appendix 14

The audio quality measurement method according to any one of Appendixes 11 to 13, comprising:
by the computer, recalculating a payload CRC value of each of a plurality of packets picked up during a predetermined time period, and calculate a frame discard rate based on a ratio of the recalculated payload CRC values of the packets matching payload CRC values stored in the packets.

### Appendix 15

The audio quality measurement method according to any one of Appendixes 12 to 14, comprising:
by the computer, estimating audio quality based on a frame discard rate obtained by summing a plurality of frame discard rates calculated using methods different from each other.

### Appendix 16

An audio quality measurement method comprising:
by a computer, picking up a packet conforming to an RFC (Request For Comments) 3267 protocol from a network;
calculating a packet loss rate based on a Q bit stored in a payload of the packet; and
estimating audio quality based on the packet loss rate.

### Appendix 17

The audio quality measurement method according to Appendix 16, comprising:
by the computer, calculating a packet loss rate based on a ratio of Q bits stored in each of a plurality of packets picked up during a predetermined time period being a predetermined value.

### Appendix 18

A program causing a computer to execute:
picking up a packet conforming to an IuUP (Iu User Plane) protocol from a network;
calculating a frame discard rate based on at least one of a frame number, FQC (Frame Quality Classifier), header CRC (Cyclic Redundancy Check), and payload CRC stored in the packet; and
estimating audio quality based on the frame discard rate.

### Appendix 19

A program causing a computer to execute:
picking up a packet conforming to an RFC (Request For Comments) 3267 protocol from a network;
calculating a packet loss rate based on a Q bit stored in a payload of the packet; and
estimating audio quality based on the packet loss rate.

### Appendix 20

A computer-readable storage medium storing the program according to Appendix 18 or 19.

1-17. (canceled)

18. An audio quality measurement apparatus, comprising:
a packet reception unit that picks up a packet conforming to an RFC (Request For Comments) 3267 protocol from a network;
an analysis unit that calculates a packet loss rate based on a Q bit stored in a payload of the packet; and
a quality measurement unit that estimates audio quality based on the packet loss rate.

19. The audio quality measurement apparatus according to claim 18, wherein
the analysis unit calculates a packet loss rate based on a ratio in which the Q bit is at a predetermined value, the Q bit being stored in each of a plurality of packets picked up during a predetermined time period.

20. An audio quality measurement method comprising:
picking up a packet conforming to an RFC (Request For Comments) 3267 protocol from a network;
calculating a packet loss rate based on a Q bit stored in a payload of the packet; and
estimating audio quality based on the packet loss rate.

21. A non-transitory computer-readable storage medium storing a program that causes a computer to execute:
picking up a packet conforming to an RFC (Request For Comments) 3267 protocol from a network;
calculating a packet loss rate based on a Q bit stored in a payload of the packet; and
estimating audio quality based on the packet loss rate.
